(19) United States
(12) Patent Application Publication
(10) Pub. No.: US 2008/0110948 A1
(43) Pub. Date: May 15, 2008

(54) PORTABLE, ADJUSTABLE, VEHICLE-MOUNTED SPORTING ARTICLES HOLDER

(76) Inventor: Robert Joseph Sutter, Alpharetta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/938,426

(22) Filed: Nov. 12, 2007

Related U.S. Application Data
(60) Provisional application No. 60/859,285, filed on Nov. 15, 2006.

(51) Int. Cl. B60R 7/14; B60R 7/00

(52) U.S. Cl. 224/282; 224/539

(57) ABSTRACT

A portable, adjustable, sporting articles holder for use within a vehicle. A base unit positions the device on the floor of a vehicle. A plurality of telescoping legs are attached to the base and extend upwardly therefrom for contacting the ceiling of the vehicle. A plurality of multi-function clamps are frictionally held to the telescoping legs, and the clamps are slidably adjustable with respect to the telescoping legs for vertical adjustment of the clamps. A plurality of tubular connecting bars are held in place by the clamps, and the tubular connecting bars are also slidably adjustable. Attached to the ends of the tubular connecting bars are a plurality of planar receiving members capable of receiving and supporting a number of sporting articles, such as fishing rods and firearms, wherein the sporting articles are received by a plurality of adjacent, spaced apart cut-outs contained within the receiving members.

### CROSS REFERENCE TO RELATED APPLICATIONS

This application claims the benefit under 35 U.S.C. §119(e) of U.S. Provisional Pat. No. 60/859,285, filed Nov. 15, 2006, and entitled “Combination Fishing Rod and Gun Rack System,” which is incorporated herein by reference.

### FIELD OF THE INVENTION

The present invention relates generally to a sporting articles holder, and more particularly to a portable, adjustable, vehicle-mounted sporting articles holder that easily and quickly mounts to the inside of a vehicle to securely and effectively transport fishing rods, long-barreled firearms, and other sporting articles and outdoor equipment.

### BACKGROUND

Hunters, fishermen, and sportsmen often require effective and safe transportation of their sporting articles, including fully-rigged fishing rods, long-barreled firearms, and related accessories in a vehicle. Such people frequently need to transport a number of firearms or fishing rods, and it is important to transport these items securely to prevent them from moving or shifting during transport, and thus becoming damaged or damaging other items in the vehicle. It is also important to have enough room in the vehicle to transport accompanying accessories and other items along with the sporting articles, and to not displace a passenger by having to put firearms or fishing rods in a passenger seat. Additionally, it is often desirable to switch back and forth easily and quickly between transporting firearms and fishing rods. Furthermore, it is preferred to transport these items inside, rather than outside, of the vehicle to protect them from rain, wind, and other elements.

Gun racks and fishing rod holders are known in the art. Previous racks and holders have been rigid structures that were not easily adjusted or altered to fit different shaped vehicles or accommodate different sized weapons, fishing rods, or like items and their accessories. Some vehicles have larger rear cargo areas than others, or may have different seating configurations, and thus racks or holders that cannot move or adjust may not work in many vehicles. Further, a number of devices require the use of tie down straps that may not accommodate all vehicles. Additionally, prior devices could not be quickly and easily adjusted, if at all, to carry fishing rods or firearms at varying angles and heights within a vehicle. Because of this, it can be difficult to transport other items of varying sizes and shapes along with the rack or holder and accompanying elongate sporting articles.

Further, prior devices have been designed and utilized to transport either firearms or fishing rods, but not both. If a sportsman wishes to switch back and forth between transporting fishing rods or long-barreled firearms, or any other sporting articles, the sportsman must switch back and forth between separate rack systems, and accordingly install and remove each respective system every lime the alternate use is desired. This becomes particularly difficult when the devices require permanent installation in or on a vehicle with screws, clamps or other fastening devices, as most devices do, or when elaborate set up and removal is required.

Moreover, retaining and transporting fully assembled and rigged fishing rods inside of a vehicle can be particularly difficult. Most prior systems employ simple tubes or holders that carry a fishing rod on the outside of a vehicle. Fishing rods or other sporting articles carried by these systems are subject to damage from the outside elements. Also, it can be difficult to install and remove these devices from a vehicle because they usually require installation on the roof of a vehicle.

Accordingly, gun racks and fishing rod holders have been used before, but previous systems have all been simplistic structures that cannot be adjusted to accommodate different vehicles and carry varying numbers of sporting articles, including firearms, fishing rods, and other accessories safely and securely with minimal installation or damage to a vehicle.

### SUMMARY OF THE INVENTION

Briefly described, and according to a preferred embodiment, the present invention relates to a sporting articles holder that easily and quickly mounts to the inside of a vehicle to securely and effectively transport fishing rods, long-barreled firearms, and other sporting articles and outdoor equipment. Although the preferred embodiment is described as a holder of fishing rods and firearms, the invention is not limited to such uses. For instance, any elongate article may be secured and transported by the present invention, including golf clubs, oars and paddles, baseball bats, skis, umbrellas, and the like.

According to one embodiment, the sporting articles holder includes a support assembly for positioning and securing the device inside of a vehicle. A plurality of multi-function adjustable clamps are connected to the support assembly by frictional engagement. Further, an adjustable, rotatable rack assembly is connected to the multi-function clamps for receiving and securing elongate sporting articles.

According to one aspect, the support assembly includes a rigid base member for positioning the device on the floor of a vehicle. A plurality of elongate support legs are affixed to the rigid base member and extend upwardly therefrom. Additionally, an elongate extendable member is slidably connected to each of the support legs, such that the extendable members are capable of vertical translational movement in and out of the support legs, thus creating a telescoping action between the extendable members and the support legs. The extendable members may be extended vertically until they contact the inside roof of a vehicle, and then locked into place to create a compression hold with the vehicle. In one aspect, a flexible pad is affixed to each extendable member by a ball-and-socket or similar type connector for adapting to slopes and different angles present on the ceilings of vehicles.

According to another aspect, the adjustable, rotatable rack assembly comprises a plurality of receiving members, each receiving member further comprising a plurality of adjacent, spaced apart cut-outs configured for receiving and retaining various sporting articles. The rack assembly further includes a plurality of tubular connecting bars which are slidably and frictionally connected to the multi-function clamps. The receiving members are perpendicularly connected to the opposing ends of each tubular connecting bar.

According to still another aspect, the adjustable, rotatable rack assembly is capable of rotational movement about the axis of the multi-function clamps, and also translational movement along the axes of the tubular connecting bars for adjusting and adapting to vehicles of different sizes. Further, the multi-function clamps are slidably moveable along the support legs, thus the entire rack assembly is capable of corresponding vertical movement along the support legs for additional adjustment within the vehicle.

According to yet another aspect, the receiving members are made of durable, rigid rubber held between a pair of rigid plastic plates. The rubber allows the receiving members to be shaped during manufacture to accommodate sporting articles of various shapes and sizes, and it creates a frictional contact between the sporting articles and the receiving members.

According to a further aspect, a holding strap is connected from one tubular connecting bar to a second tubular connecting bar for retaining the sporting articles to the receiving members when the device is in use.

According to an additional aspect, a pair of rotatable arcuate accessory arms are frictionally held by the multi-function adjustable clamps for carrying sporting-related accessories.

Another embodiment of the invention is a holder of sporting articles for use within a vehicle, and comprises a base for positioning the device on the floor of the vehicle. A plurality of telescoping legs are attached to the base and extend upwardly therefrom for contacting the ceiling of a vehicle. A plurality of multi-function adjustable clamps are frictionally held to the telescoping legs, and the multi-function clamps are slidably adjustable with respect to the telescoping legs for vertical adjustment of the clamps and any components connected thereto. Further, a plurality of tubular connecting bars are held in place by the multi-function clamps, and the tubular connecting bars are also slidably adjustable with respect to the clamps. Attached to the ends of the tubular connecting bars are a plurality of planar receiving members capable of receiving and supporting a number of sporting articles, wherein the sporting articles are received by a plurality of adjacent, spaced apart cut-outs contained within the receiving members.

According to one aspect, each vertical telescoping leg includes a ratcheting collar or mechanism capable of telescoping the leg vertically until it contacts the roof of the vehicle and then locking the leg into a locked position. In another aspect, a flexible pad is attached to the top of each telescoping leg by a ball-and-socket connector for adapting to slopes and different angles present on the ceilings of vehicles.

According to another aspect, the planar receiving members are made of durable, rigid rubber held between a pair of rigid plastic plates to enhance the frictional contact between the sporting articles and the receiving members.

According to a further aspect, a holding strap is connected from one tubular connecting bar to a second tubular connecting bar for retaining the sporting articles to the receiving members when the device is in use.

According to yet another aspect, a pair of rotatable arcuate accessory arms are frictionally held by the multi-function adjustable clamps for carrying any accessories the sportsman desires.

Still more particularly described, an embodiment of the present invention is a fishing rod and firearm holder for use within a vehicle. This embodiment includes a rectangular base plate for positioning the device on the floor of a vehicle. A pair of base supports are attached along opposing sides of the top surface of the rectangular base plate for receiving and supporting a pair of elongate support legs. The legs are affixed to the base supports and extend upwardly therefrom. In this embodiment, a pair of extendable members are slidably connected to the elongate support legs by a pair of ratcheting collars, such that the ratcheting collars are capable of vertically extending and locking the extendable members into a varying number of positions. A flexible pad is attached to the top of each of the extendable members by a ball-and-socket connector for contacting the roof of a vehicle and creating a compression hold therewith.

According to another aspect, a pair of multi-function adjustable clamps are frictionally held to the support legs through one of a plurality of receiving sleeves in the clamps, and these clamps are slidably adjustable with respect to the support legs. The clamps also hold a plurality of tubular connecting bars, and these connecting bars are also slidably adjustable with respect to the clamps for translational movement of the connecting bars.

According to a further aspect, the device includes a pair of planar receiving members attached to opposing ends of the tubular connecting bars for supporting and retaining fishing rods, firearms and other sporting articles. The planar receiving members include a plurality of adjacent, spaced apart cut-outs positioned for receiving the sporting articles. In this embodiment, the planar receiving members are capable of rotational movement about the axis of the multi-function clamps, and translational movement along the axes of the tubular connecting bars. The planar receiving members and the tubular connecting bars are also capable of vertical translational movement corresponding to the slidable movement of the multi-function clamps along the support legs for adjusting to a number of different vehicles.

According to one aspect, the planar receiving members are made of durable, rigid rubber held between a pair of rigid plastic plates to enhance the frictional contact between the sporting articles and the receiving members. In a further aspect, a holding strap is connected from one tubular connecting bar to a second tubular connecting bar for retaining the sporting articles to the receiving members when the device is in use.

According to yet another aspect, a pair of rotatable arcuate accessory arms are frictionally held by the multi-function adjustable clamps for carrying any sporting-related accessories.

These and other aspects, features, and benefits of the present invention(s) will become apparent from the following detailed written description of the preferred embodiments taken in conjunction with the following drawings, although variations and modifications therein may be effected without departing from the spirit and scope of the novel concepts of the disclosure.

### BRIEF DESCRIPTION OF THE DRAWING FIGURES

FIG. 1 is a perspective view of the portable, adjustable, vehicle-mounted sporting articles holder according to a preferred embodiment of the invention, showing the adjustable, rotatable rack assembly in a rotated position with two fishing rods in phantom.

FIG. 2A is a perspective view of the sporting articles holder according to the preferred embodiment of the invention, as the holder would be used in practice with long-barreled firearms.

FIG. 2B is a perspective view of the sporting articles holder according to the preferred embodiment of the invention, as the holder would be used in practice with fishing rods.

FIG. 3A is a side view of the sporting articles holder according to the preferred embodiment of the present invention.

FIG. 3B is a side view of the sporting articles holder according to the preferred embodiment of the present invention, showing the adjustable, rotatable rack assembly in two rotated positions in phantom, and showing an elongate extendable member in an extended position in phantom.

FIG. 3C is a side view of the sporting articles holder according to the preferred embodiment of the present invention, showing the adjustable, rotatable rack assembly in a vertically adjusted position in phantom, and showing a flexible pad in various positions in phantom.

FIG. 3D is a side view of the sporting articles holder according to the preferred embodiment of the present invention, showing the adjustable, rotatable rack assembly horizontally adjusted in two positions in phantom, and showing an arcuate accessory arm rotatably adjusted in phantom.

FIG. 4 is a front view of the sporting articles holder according to the preferred embodiment of the present invention.

FIG. 5 is an exploded perspective view of the sporting articles holder according to the preferred embodiment of the present invention.

### DETAILED DESCRIPTION

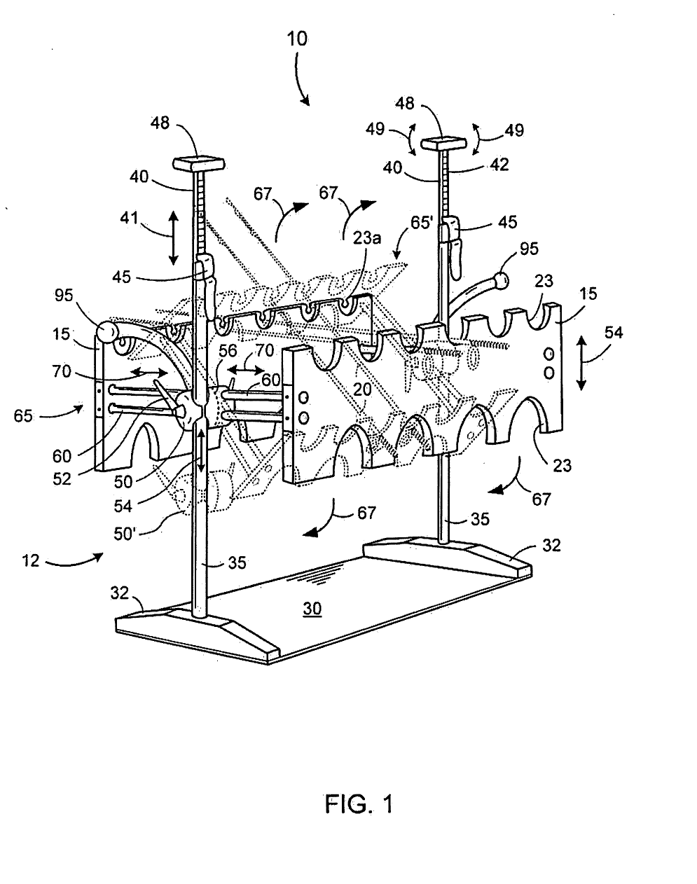

Referring now to the drawings, in which like numerals illustrate like elements throughout the several drawing figures, FIG. 1 illustrates a portable, adjustable, vehicle-mounted sporting articles holder 10 constructed in accordance with the preferred embodiment of the present invention. Preferably, the sporting articles holder 10 includes a support assembly 12, which comprises a base plate 30, a pair of base supports 32 attached to the base plate 30, a pair of elongate support legs 35 affixed to the base supports 32, a pair of elongate extendable members 40 slidably connected to the support legs 35 by a pair of ratcheting collars 45, and a pair of flexible pads 48 connected to the tops of the extendable members 40.

The base plate 30 is positioned at the bottom of the device. When in use, the base plate 30 typically rests on the floor of a vehicle, but can also be used outside of a vehicle for long term storage of sporting articles. Attached to the top surface of the base plate are two base supports 32, configured for holding in place two elongate support legs 35. The base supports 32 may be attached to the base plate in any number of ways, including by screws, bolts, nails, industrial adhesives, or the like. Alternatively, the base plate 30 and base supports 32 may be manufactured as one distinct, rigid unit, so long as the unit has the capability to receive and support the support legs 35. The base plate 30 and base supports 32 are preferably made of a rigid, durable material, such as high-strength plastic, metal, or wood, so as to provide a solid foundation for the device.

The elongate support legs 35 are preferably durable, hollow, cylindrical poles or pipes, capable of supporting the device, and are additionally light-weight for easy transport and portability. These support legs 35 are preferably comprised of metal or a high strength plastic. In the preferred embodiment, the support legs 35 are held upright by holes in the base supports 32, and are attached permanently thereto with screws, but may be attached via bolts, nails, industrial adhesives, or the like.

Still referring to FIG. 1, attached to the elongate support legs 35 are a pair of elongate extendable members 40. Preferably, these extendable members 40 are slidably engaged with the support legs 35 such that the extendable members have a diameter slightly smaller than the inside diameter of the hollow support legs to allow the extendable members to extend vertically in and out of the support legs. At the connection point between a support leg 35 and an extendable member 40 is a ratcheting collar 45 capable of locking an extendable member into place at various positions. The extendable members 40 include notches 42 which interlock with corresponding teeth (not shown) in the ratcheting collars 45. The notches 42 are preferably small holes or slots cut into one side of the extendable member 40 for interlocking engagement with the teeth of the ratcheting collar 45. Within the preferred embodiment, the ratcheting collar 45 is constructed as described in Huang, U.S. Pat. No. 5,443,342, the disclosure of which is incorporated herein by reference. However, as one skilled in the art will appreciate, any mechanism may be used that allows slidable engagement of an extendable member 40 with a support leg 35, and further allows for the extendable member to lock into place at various extended heights.

Just as with the support legs 35, the extendable members 40 are preferably durable, hollow, cylindrical poles or pipes, capable of supporting the device, are additionally light-weight for easy transport and portability, and are preferably comprised of metal or high strength plastic. At the uppermost ends of the extendable members 40 are a pair of flexible pads 48, which contact the inside of the roof of a vehicle when the device is in use. The flexible pads 48 are preferably made of a semi-rigid rubber or plastic material, and include ridges or small protrusions on their uppermost surface for increasing the frictional contact with the roof of the vehicle. In the preferred embodiment, the flexible pads 48 are attached to the extendable members 40 by the use of a ball-and-socket connector (not shown) that allows the pad to pivot and rotate about the axis of the extendable members as shown by arrows 49. Because the flexible pads 48 are semi-rigid, and because they can move and rotate on the top of the extendable members 40, the pads can adjust and conform to different angles and variations that may be present on the roof of the vehicle.

When the device is in use, the extendable members 40 are extended upward, as shown by arrow 41, until the flexible pads 48 contact the inside roof of a vehicle. The ratcheting collars 45 are used to extend the extendable members 40 until a compression force is created between the extendable members and the roof of the vehicle, and the extendable members are subsequently locked into place. This compression force is what holds the device in a set position when the vehicle is in transit. Essentially, the device is compressed between the roof and floor of the vehicle, and is thus held in position by frictional engagement.

Positioned along each elongate support leg 35 is a multi-function adjustable clamp 50, which is held in position to the support leg 35 by frictional engagement. When an adjustment knob 52 is turned about the central axis of the adjustable clamp 50, the clamp either releases or tightens depending on which way the knob is turned, and the corresponding frictional force associated with all parts to which the clamp is connected either decreases or increases accordingly. Thus, as the knob 52 is turned to release some of the frictional force between the clamp 50 and the support leg 35, the clamp is able to move vertically up and down the support leg, as shown by arrow 54.

Still referring to FIG. 1, the clamp 50 is shown in its initial position, and in a corresponding adjusted position 50′ shown in phantom. The multi-function clamp 50 may be loosened, shifted vertically, and then re-tightened at any position along the support leg 35, thus allowing the device to carry sporting articles at virtually any height within a vehicle. Although only the multi-function clamp 50 is shown in phantom 50′ as vertically shifted, it will be understood by one having ordinary skill in the art that any other components attached to the clamp 50 will shift correspondingly along with the clamp. Additionally, because there are two clamps 50 shown in the preferred embodiment, both clamps should be shifted equally, and thus remain at the same vertical height, to allow the device to function properly. Such a preferred clamp 50 is commercially available from The Manfrotto Group, a division of Vitec Group, PLC, of Surrey, United Kingdom, Model Number 124, entitled “Pivoting Clamp for Light Boom,” the details of which are available in reference materials supplied by the manufacturer. As one having ordinary skill in the art will understand, any clamps performing the same function and including the same characteristics as these particular clamps may be used with the invention.

As further shown in FIG. 1, the clamps 50 have a plurality of receiving sleeves capable of receiving and retaining multiple elongate cylindrical objects, such as the support legs 35. When the adjustment knobs 52 are rotated counter clockwise, the frictional force created by the clamp 50 is released, and any cylindrical objects being held by the clamp are allowed to slide freely within the receiving sleeves of the clamp. As the adjustment knobs 52 are turned back clockwise, the frictional force within the clamp increases, and the cylindrical objects are locked into place. Further, each clamp 50 is divided into two distinct pieces, shown by dividing line 56, and these two pieces are capable of rotating against each other about the central axis of the clamp when the clamp is in a loosened state, and then re-tightening into a locked position after rotation. This rotational movement allows the device to carry sporting articles at varying angles within a vehicle, and to perform other functions, discussed in greater detail below.

Attached to each multi-function clamp 50 are a pair of parallel, spaced apart, tubular connecting bars 60. These connecting bars 60 are frictionally engaged with the clamp 50 in a similar manner as the support legs 35. These connecting bars 60 are preferably comprised of hollow metal tubes, but may comprise rigid plastic, wood, or other durable, light-weight material. Affixed to the opposing ends of the tubular connecting bars 60 are a pair of planar receiving members 15 for receiving and supporting elongate sporting articles, such as fully-rigged fishing rods, long-barreled firearms, and the like. The receiving members 15 are preferably connected to the connecting bars 60 by bolts or screws, but may be connected in any number of ways.

In the preferred embodiment, the planar receiving members 15 are constructed of durable, rigid rubber or plastic. This construction allows the receiving members 15 to be light-weight, while at the same lime being rigid enough to securely carry heavy sporting articles such as shot guns, long-barreled firearms, and fully-rigged fishing rods. Furthermore, the consistency of the rubber material enhances the frictional engagement between the sporting articles and the receiving members 15, thus preventing the movement or shifting of held sporting articles when the device is in use. Additionally, each planar receiving member 15 includes a plurality of adjacent, spaced apart cut-outs 23 positioned along each lateral edge of the receiving members 15, which are configured and shaped for receiving a variety of sporting articles. Because the receiving members 15 are preferably comprised of rubber, the cut-puts 23 can be cut into whatever shape the user desires to accommodate sporting articles of all shapes and sizes.

FIG. 1 further shows a pair of fishing rods 20 (shown in phantom) being held by the planar receiving members 15. Each fishing rod 20 is placed in one of the plurality of adjacent, spaced apart cut-outs 23. In the preferred embodiment, most of the cut-outs 23 are arcuate in shape, so as to fit a variety of sporting articles of all shapes and sizes. However, as discussed above, one having ordinary skill in the art will understand that these cut-outs 23 do not necessarily have to be arcuate, and may be specially shaped and configured to fit any particular elongate sporting article. For instance, the preferred embodiment includes smaller, key-hole shaped cut-outs 23a for releasably retaining thin, elongate shafts incorporated in most fishing rods.

The planar receiving members 15, together with the tubular connecting bars 60, comprise an adjustable, rotatable rack assembly 65. This rack assembly 65 can be adjusted to a variety of different positions for carrying sporting articles at different arrangements within a vehicle to ensure the sporting articles will fit within the vehicle, and to allow more cargo to be carried in the vehicle along with the sporting articles. The rack assembly 65 may be rotated about the axis of the multi-function clamps 50 and locked at any position between the support legs 35 by loosening the multi-function clamps, rotating the rack assembly, and then locking the clamps 50 back into place. An example of the rack assembly 65 in a rotated position 65′ is shown in phantom in FIG. 1, with the rotational movement shown by arrows 67. The rack assembly 65 can also move in a direction parallel to the axis of the tubular connecting bars 60, as shown by arrows 70. Further, as discussed previously, the entire rack assembly 65 can move vertically as the multi-function adjustable clamps 50 are shifted along the support legs 35. All of these ranges of motion will be discussed in greater detail below.

An advantage of the preferred embodiment of the present invention is that the receiving members 15 are configured such that one lateral edge of each corresponding receiving member is configured with cut-outs 23 capable of receiving fishing rods, whereas the other lateral edge of each corresponding receiving member 15 has cut-outs 23 shaped to receive firearms. Thus, a user can shift back and forth quickly and easily between transporting fishing rods or long-barreled firearms by simply loosening the multi-function clamps 50, rotating the rack assembly approximately 180°, and then re-tightening the clamps with the rack assembly 65 in its new position.

The adjustable sporting articles holder 10 also includes a pair of arcuate accessory arms 95 frictionally engaged with the multi-function clamp 50. The accessory arms 95 are intended to carry sporting-related accessories during transit, such as jackets, pants, hats, fishing nets, strapped coolers, boots, and other sporting items. These sporting-related accessories are hung from or draped across the accessory arms 95 in any manner the user desires. Preferably, the accessory arms 95 are made of metal tubing or pipe, but can be made of plastic, wood, or any other rigid material. These accessory arms 95 are capable of horizontal rotation about an axis parallel to the axis of the support legs 35 to allow the user to position the accessory arms as he or she desires. Alternatively, the accessory arms 95 can be altogether removed from the device by simply loosening the multi-function clamps 50, taking put the accessory arms, and then re-tightening the clamps.

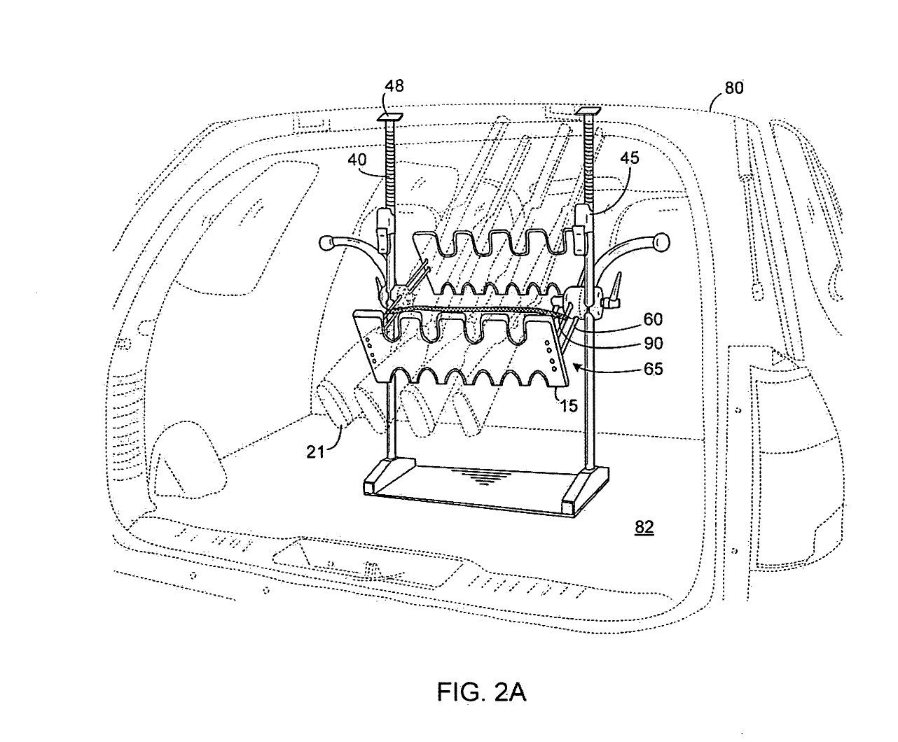

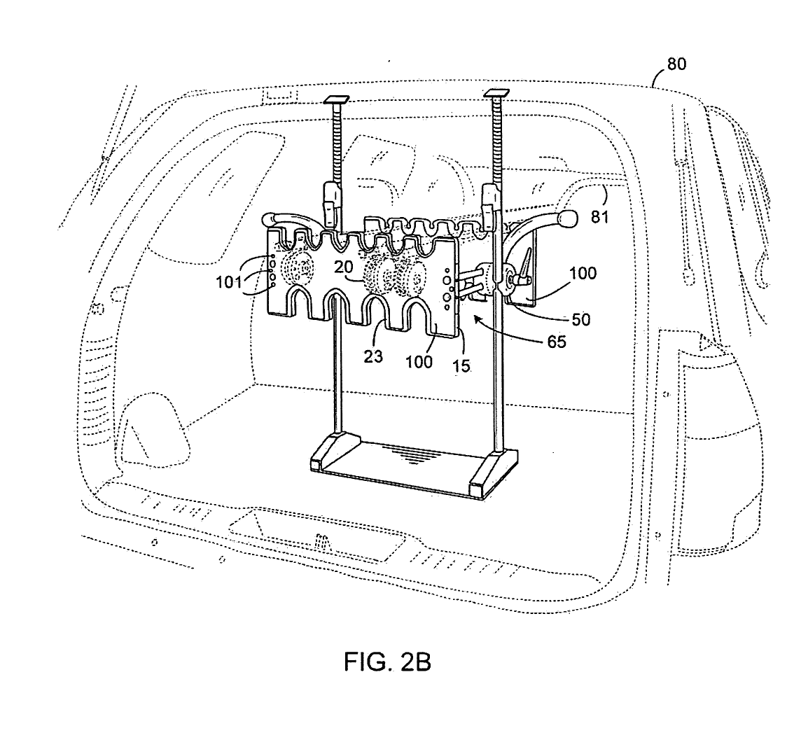

FIG. 2A shows the preferred embodiment of the invention as it would be used in practice with long-barreled firearms 21 (shown in phantom). Preferably, the device is positioned in the rear cargo area 82 of a vehicle 80. The device potentially may be used in any vehicle, but it will most commonly be utilized with sport utility vehicles (SUVs), station wagons, vans, and select pickup trucks. The rack assembly 65 is shown in a rotated position such that the firearms 21 are resting at an upright angle with respect to the horizontal floor of the vehicle 80. This rotated position allows for the safe and secure transfer of a plurality of firearms 21. Long-barreled firearms 21 come in many different shapes and sizes, as do the vehicles 80 in which they are carried, and the rotational adjustment of the device allows for the firearms to fit in the vehicle in a satisfactory arrangement to the user. This rotational positioning also enhances safety because the firearms 21 can be transported such that they are pointed away from any passengers in the vehicle 80 should one of the firearms accidentally discharge. Additionally, because the firearms 21 are securely held in a distinct position, they will not shift or move during transit, thus protecting the firearms and other accessories from damage, and lessening the possibility of an accidental discharge. Another added advantage of transporting firearms 21 in this way is that if the rifle or long-barreled firearm 21 has an optical scope (not shown) attached to it, the scope will be prevented from misalignment during transit due to bumping into other items in the vehicle 80.

In the preferred embodiment, the firearms 21 are held to the device by gravity, frictional engagement with the planar receiving members 15, and by a holding strap 90. The holding strap 90 preferably includes a hook and loop fastener, such as VELCRO®, so that it may be tightened down upon the firearms 21 to secure them in place. However, as will be understood by one having ordinary skill in the art, the holding strap 90 may be any strap or belt that is capable of retaining the firearms 21 or fishing rods 20 against the receiving members 15. Preferably, the holding strap 90 is connected to the tubular connecting bars 60 by wrapping the strap around the diameter of one of the connecting bars 60 on each side of the device, and securing the holding strap with a brad or snap.

As shown in FIG. 2A, the device is positioned in the rear cargo area 82 of a vehicle 80, and is held in place by a compression force on the device between the ceiling and floor of the vehicle. This force is accomplished by pressing the flexible pads 48 against the inner ceiling of the vehicle 80 by extending the elongate extendable members 40 until a forceps established. The extendable members 40 are then locked into a fixed position by the ratcheting collars 45. In this way, the device presses up on the ceiling and down on the floor of the vehicle 80, and thus holds itself in place.

FIG. 2B illustrates the preferred embodiment of the invention as it would be used in practice with fishing rods 20. As shown, the rack assembly 65 is set in a horizontal position so that the fishing rods 20 may extend above the seats 81 toward the front of the vehicle 80. In general, fishing rods are fairly long, and it has been difficult previously to transport them inside of a vehicle. Often times sportsmen will simply strap the fishing rod 20 to the outside of the vehicle, where it is unprotected from the elements. The preferred embodiment of the present invention allows for the secure transport of a plurality of fishing rods 20 inside of a vehicle by allowing them to extend over the seals 81, but securely keeping them in a retained position. Furthermore, the rack assembly 65 may be raised or lowered vertically to accommodate a varying number of vehicles 80 by loosening, shifting, and re-tightening the multi-function clamps 50 at a desired height.

FIG. 2B further shows a pair of rigid plastic plates 100 attached to each planar receiving member 15 to strengthen the receiving members. In an embodiment of the present invention, a plate 100 is affixed to the inside and outside of each receiving member 15 by screws 101, but may be affixed by glue, bolts, or any other fastening mechanism or combination thereof. These plates 100 are preferably the same shape as the receiving members 15, but are slightly smaller in size so that the plates do not interfere with the frictional engagement between the sporting articles and the receiving members 15 created by the rubber at the cut-outs 23.

In a further embodiment of the present invention, the plastic plates 100 are decorated to make them aesthetically pleasing. The plates 100 may be adorned with a wood-grain finish to match the vehicle 80 interior, or a camouflage finish to go with a sportsman theme, or any other finish the user desires.

Although it is not shown in FIG. 2B, it is understood that the holding strap 90 may be used to retain the fishing rods 20 to the receiving members 15 just as it is used to retain the firearms 21 to the receiving members 15.

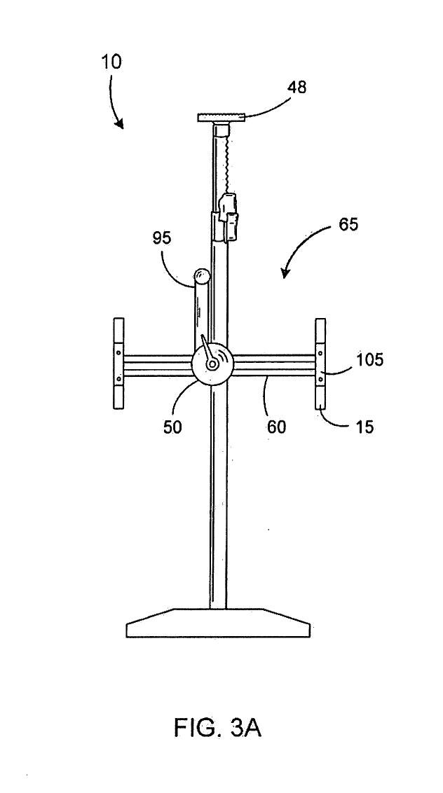

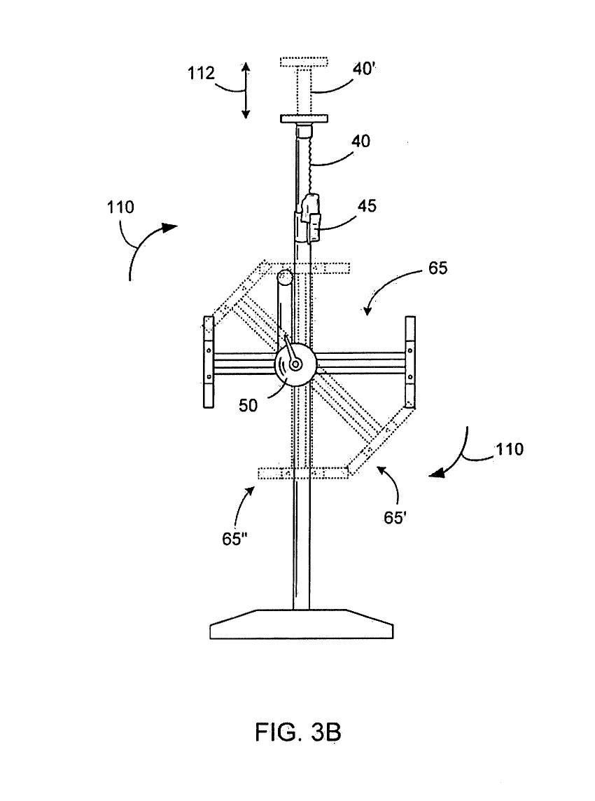

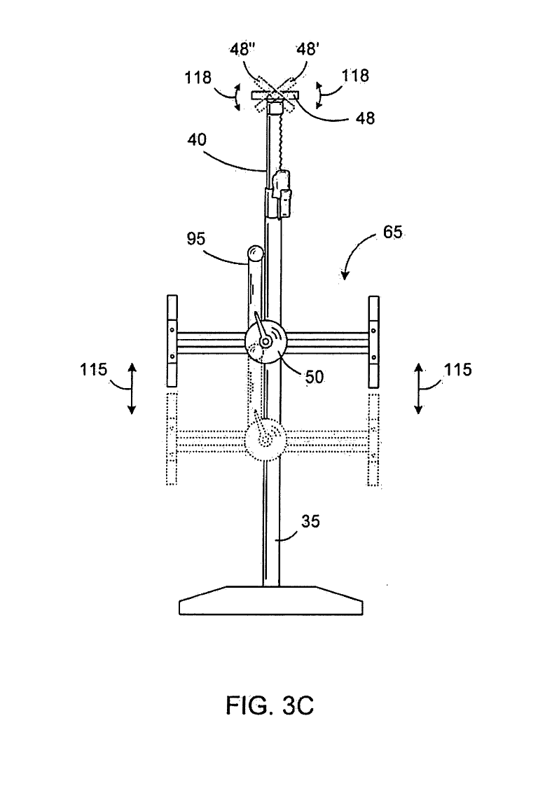

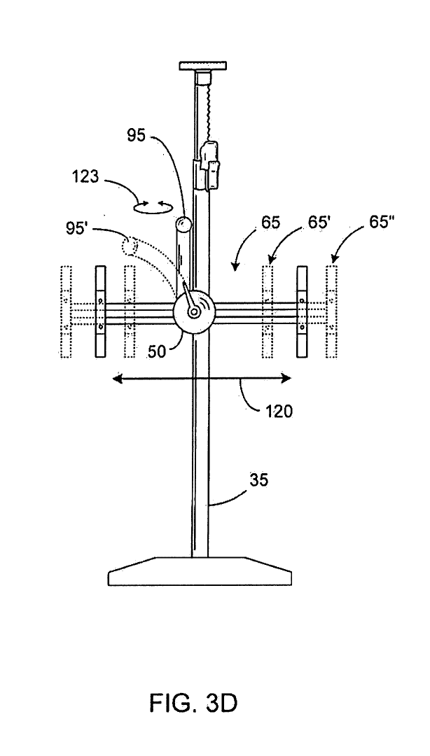

FIG. 3A is a side view of the preferred embodiment of the sporting articles holder 10 with the adjustable rack assembly 65 fixed in a horizontal position. This view better illustrates the positioning of the arcuate accessory arms 95 and their respective attachment to the multi-function clamps 50. As shown, the accessory arm 95 is extending upward and outward (towards the viewer of the figure). FIG 3A also illustrates the ridges or protrusions on the top surface of the flexible pads 48 for frictionally contacting the roof of the vehicle 80.

FIG. 3A further shows a pair of connector plates 105 affixed to the outside ends of the planar receiving members 15. In an embodiment of the present invention, these connector plates 105 are preferably made of aluminum or another similar metal. Through the plates are drilled screws, bolts, or other fastening means to firmly and securely attach the tubular connecting bars 60 to the receiving members 15.

FIG. 3B is a side view of the device illustrating the rotation of the rack assembly 65 and the vertical motion of one of the extendable members 40. The rack assembly 65 is shown initially in a horizontal position, and at two rotational positions, 65′ and 65″ (in phantom), as the rack assembly 65 rotates in a clockwise direction about the horizontal axis of the multi-function clamps 50. The direction of motion is indicated by arrows 110. While only two positions are shown, 65′ and 65″, it will be understood by one having ordinary skill in the art that the preferred embodiment of the rack assembly 65 can be rotated and locked at any position in a 360° arc around the multi-function clamps 50. This rotational movement enables the user to transport sporting articles at any angle within a vehicle 80. Further, although not shown, sporting articles may be efficiently stored oil the device at position 65″ when the device is not in use in a vehicle 80, and instead, long-term storage is desired.

As mentioned, FIG. 3B also shows an extendable member 40 in an extended position 40′ (in phantom). The extendable members 40 are extended vertically by use of the ratcheting collars 45, with corresponding movement shown by arrows 112. As previously discussed, this vertical extension is what creates the compression force on the device between the ceiling and floor of a vehicle, thus holding the device in place.

FIG. 3C is a side view of the device illustrating the vertical movement of the rack assembly 65 (as well as the multi-function clamps 50 and the accessory arms 95) along the elongate support legs 35, as indicated by movement arrows 115. As discussed previously, this vertical movement allows the device to retain sporting articles at varying heights within a vehicle 80 so as to accommodate a wide range of vehicles. Although only one vertically shifted position is shown (in phantom), it will be understood by one having ordinary skill in the art that the preferred rack assembly 65, and any corresponding components, can be shifted vertically and locked at any position along the support legs 35.

FIG. 3C also shows the pivoting movement of a flexible pad 48 around the top of an extendable member 40. The flexible pads 48 are preferably attached to the extendable members 40 via ball-and-socket connectors (not shown) to allow the flexible pads to shift and pivot around the extendable members 40 to better contact the ceiling of a vehicle 80. The flexible pad 48 is shown at two pivoted positions, 48′ and 48″ (in phantom), with corresponding movement shown by arrows 118. Again, although only two pivoted positions are shown, it will be understood by one having ordinary skill in the art that the flexible pads 48 can be moved to a variety of positions to accommodate contours in a roof or ceiling of a vehicle 80.

FIG. 3D is a side view of the preferred embodiment of the device illustrating the horizontal movement of the rack assembly 65, and the rotational movement of an accessory arm 95. The rack assembly 65 may be translated horizontally by releasing the frictional engagement of the assembly by the multi-function clamps 50, sliding the rack assembly 65 to its desired position, and then tightening the clamps 50 so as to lock the rack assembly into place. The rack assembly 65 is shown in FIG. 3D in phantom at two translated positions, 65′ and 65″, as indicated by movement arrow 120. The rack assembly 65 may be translated horizontally to better accommodate a varying number of vehicles 80. Further, this lateral translation enhances the overall adjustability of the preferred embodiment of the sporting articles holder 10.

FIG. 3D further shows the rotational movement of an accessory arm 95, and a rotated position 95′ (in phantom). This rotational movement is indicated by arrow 123. The accessory arm 95 may be rotated about its base axis, parallel to the axis of the support legs 35. The accessory arms 95 may be rotated and locked at a number of positions to carry any sporting accessories the user wishes. Preferably, this rotational movement is enabled by loosening the multi-function clamps 50, rotating the accessory arm 95, and then locking the clamp back into place. Alternatively, the accessory arms 95 may be altogether removed, if the user desires, by simply loosening the clamps 50, removing the arms 95, and then retightening the clamps.

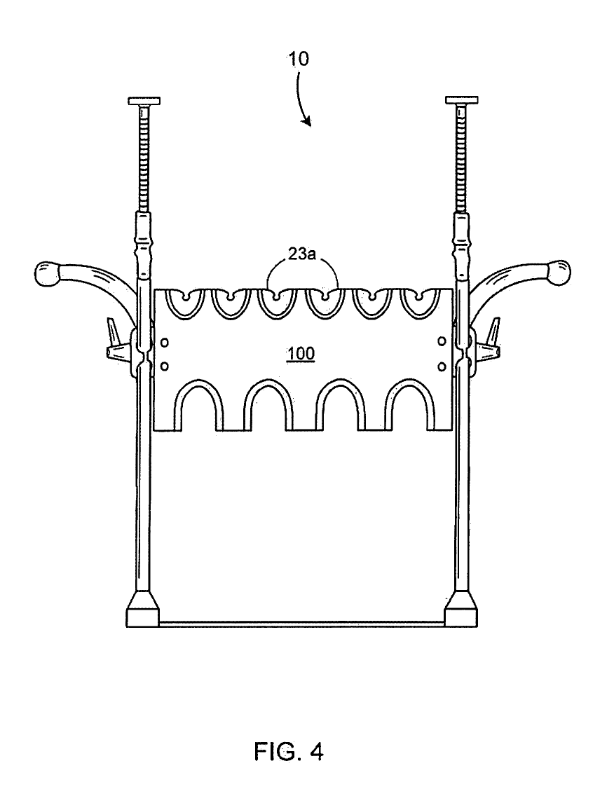

FIG. 4 is a front plan view of the preferred embodiment of the sporting articles holder 10, that more clearly illustrates the rigid plastic plates 100 and the key-hole shaped cut-outs 23a.

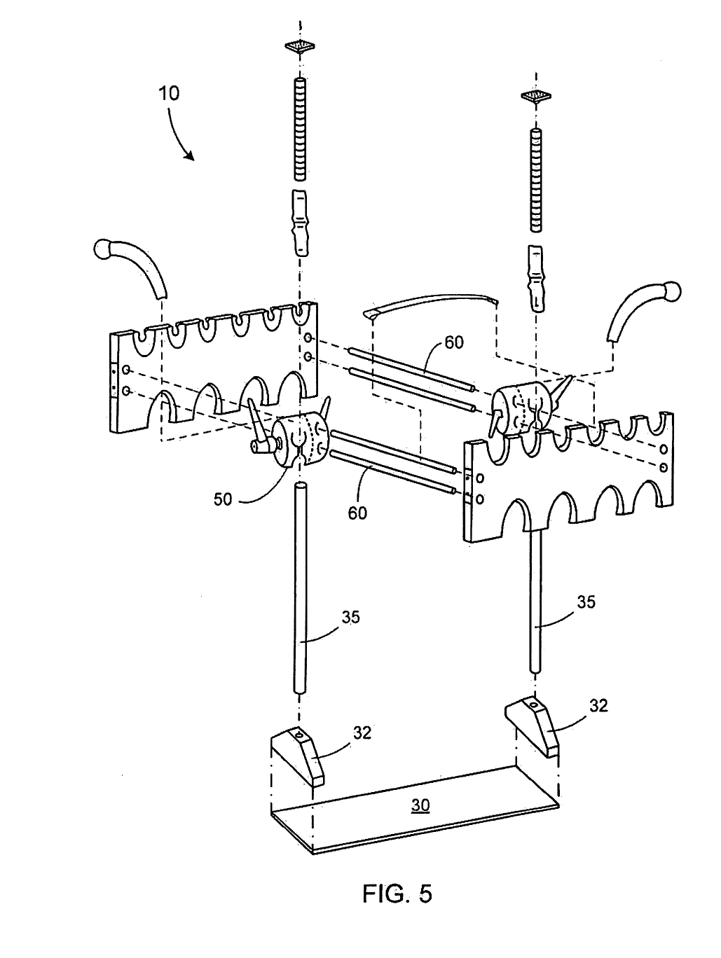

FIG. 5 is an exploded view of the preferred embodiment of the sporting articles holder 10 that more clearly illustrates how the various components are connected together. FIG. 5 more clearly demonstrates the positioning of the support legs 35 and the tubular connecting bars 60 with respect to each other and to the multi-function clamps 50. Additionally, FIG. 5 also demonstrates the positioning of the base supports 32 with respect to the base plate 30 and support legs 35.

A further modification within the inventor's contemplation as an equivalent rack assembly 65 is a toolbox or multi-purpose box capable of carrying tools, equipment, or other materials to be used by a workman or other person. Thus, carpenters, plumbers, or any other person who needs to transport and organize multiple items in a vehicle 80 may find it useful to incorporate a large box or retaining device into their vehicle that is fully adjustable and portable.

Additionally, it will be understood by one having ordinary skill in the art that while the preferred embodiment of the invention is described as a sporting articles holder 10, the embodiment may be used to support and transport any type of elongate articles, such as pipes, oars, umbrellas, golf clubs, skis, baseball bats, and the like.

As mentioned previously, the device may also be used outside of a vehicle 80 when long-term storage is desired. Sporting articles may be retained and stored on the device in a horizontal, vertical, or rotated position within a home or storage facility.

The foregoing description of the exemplary embodiments of the invention has been presented only for the purposes of illustration and description and is not intended to be exhaustive or to limit the invention to the precise forms disclosed. Many modifications and variations are possible in light of the above teachings, and the limitations of the invention are intended only as expressed in the appended claims.

What is claimed is:

1. A sporting articles holder for use within a vehicle, comprising:
a support assembly for releasably securing the device to the inside of a vehicle;
a plurality of multi-function adjustable clamps frictionally held to the support assembly; and
an adjustable, rotatable rack assembly adjustably connected the multi-function adjustable clamps for receiving and securing elongate articles.

2. The sporting articles holder of claim 1, wherein the support assembly comprises a rigid base member for positioning the device on the floor of the vehicle.

3. The sporting articles holder of claim 2, wherein the support assembly further comprises a plurality of elongate support legs affixed to the rigid base member and extending vertically therefrom.

4. The sporting articles holder of claim 3, wherein the support assembly further comprises a plurality of elongate extendable members slidably connected to the elongate support legs for translational vertical movement from the elongate support legs.

5. The sporting articles holder of claim 4, wherein the support assembly further comprises a flexible pad attached to the top of each elongate extendable member by a ball-and-socket connector for contacting the roof of the vehicle and creating a compression hold therewith.

6. The sporting articles holder of claim 1, wherein the adjustable, rotatable rack assembly comprises a plurality of receiving members, the receiving members including a plurality of adjacent, spaced apart cut-outs positioned for receiving sporting articles.

7. The sporting articles holder of claim 6, wherein the adjustable, rotatable rack assembly further comprises a plurality of tubular connecting bars slidably and frictionally engaged to the multi-function adjustable clamps, wherein the receiving members are fixedly attached to opposing ends of the tubular connecting bars.

8. The sporting articles holder of claim 7, wherein the adjustable, rotatable rack assembly is capable of rotational movement about the axis of the multi-function adjustable clamps and translational movement along the axes of the tubular connecting bars.

9. The sporting articles holder of claim 6, wherein each receiving member comprises durable, rigid rubber held between a pair of rigid plastic plates for frictionally securing the sporting articles.

10. The sporting articles holder of claim 3, wherein the multi-function adjustable clamps are slidably moveable along the support legs for corresponding vertical translation of the adjustable, rotatable rack assembly connected therewith.

11. The sporting articles holder of claim 7, further comprising a holding strap that extends from one tubular connecting bar to a second tubular connecting bar for retaining the sporting articles to the receiving members.

12. The sporting articles holder of claim 3, further comprising a pair of arcuate accessory arms frictionally held by the multi-function adjustable clamps for carrying sporting articles, the accessory arms being rotatable around a vertical axis parallel to the elongate support legs for adjustable positioning of the accessory arms.

13. A holder of sporting articles for use within a vehicle, comprising:
a base;
a plurality of vertical telescoping legs attached to the base and extending upwardly therefrom for contacting the ceiling of a vehicle;
a plurality of multi-function adjustable clamps frictionally held to the telescoping legs, wherein the clamps are slidably adjustable with respect to the telescoping legs for translational movement of the multi-function clamps;
a plurality of tubular connecting bars frictionally held by the multi-function clamps, wherein the tubular connecting bars are slidably adjustable with respect to the clamps for translational movement of the connecting bars; and
a plurality of planar receiving members perpendicularly attached to the tubular connecting bars, including a plurality of adjacent, spaced apart cut-outs positioned for receiving sporting articles, wherein the planar receiving members are rotatable around the axis of the multi-function clamps and between the telescoping legs.

14. The holder of sporting articles of claim 13, wherein the base comprises a rigid support member for positioning the device on the floor of the vehicle.

15. The holder of sporting articles of claim 13, wherein each vertical telescoping leg comprises a ratcheting collar capable of telescoping the leg vertically until it contacts the roof of the vehicle and then locking the telescoping leg info a locked position for creating a compression force with the vehicle.

16. The holder of sporting articles of claim 13, further comprising a plurality of flexible pads attached to the tops of the vertical telescoping legs by ball-and-socket connectors for contacting the roof of the vehicle and creating a compression hold therewith.

17. The holder of sporting articles of claim 13, further comprising a holding strap that extends from one tubular connecting bar to a second tubular connecting bar for retaining the sporting articles to the planar receiving members.

18. The holder of sporting articles of claim 13, further comprising a pair of arcuate accessory arms frictionally held by the multi-function adjustable clamps for carrying sporting accessories, the accessory arms being rotatable around a vertical axis parallel to the vertical telescoping legs for rotatable positioning of the accessory arms.

19. The holder of sporting articles of claim 13, wherein each planar receiving member comprises durable, rigid rubber held between a pair of rigid plastic plates for frictionally securing the sporting articles.

20. A fishing rod and firearm holder for use within a vehicle, comprising:
a rectangular base plate for positioning the device on the floor of the vehicle;
a pair of base supports attached along opposing sides of the top surface of the rectangular base plate for receiving a pair of elongate support legs;
the pair of elongate support legs affixed to the base supports and extending vertically therefrom;
a pair of elongate extendable members slidably connected to the elongate support legs by a pair of ratcheting collars, wherein the ratcheting collars are capable of vertically extending the elongate extendable members for creating a compression force with the vehicle;
a pair of flexible pads attached to the tops of the extendable members by ball-and-socket connectors for contacting thereof of the vehicle and creating a compression hold therewith;
a pair of multi-function adjustable clamps frictionally held to the support legs through one of a plurality of receiving sleeves in said clamps, wherein the clamps are slidably adjustable with respect to the support legs;
a plurality of tubular connecting bars frictionally held by the multi-function clamps through a plurality of the receiving sleeves in the clamps, wherein the tubular connecting bars are slidably adjustable with respect to the clamps; and
a pair of planar receiving members perpendicularly attached to the opposing ends of the tubular connecting bars, including a plurality of adjacent, spaced apart cut-outs positioned for receiving sporting articles, wherein the planar receiving members are rotatable around the axis of the multi-function clamps and between the elongate support legs.

21. The fishing rod and firearm holder of claim 20, further comprising a holding strap that extends from one tubular connecting bar to a second tubular connecting bar for retaining the sporting articles to the planar receiving members.

22. The fishing rod and firearm holder of claim 20, further comprising a pair of arcuate accessory arms frictionally held by the multi-function clamps through one of a plurality of receiving sleeves in said clamps for carrying sporting accessories, the accessory arms being rotatable around a vertical axis parallel to the elongate support legs for adjustable positioning of the accessory arms.

23. The fishing rod and firearm holder of claim 20, wherein each planar receiving member comprises durable, rigid rubber held between a pair of rigid plastic plates for frictionally securing the sporting articles.
